(19) United States
(12) Patent Application Publication
(10) Pub. No.: US 2026/0039037 A1
(43) Pub. Date: Feb. 5, 2026

(54) HORIZONTAL FEEDING TERMINAL BLOCK STRUCTURE

(71) Applicants: DINKLE ENTERPRISE CO., LTD., New Taipei City (TW); DINKLE ELECTRIC MACHINERY (CHINA) CO., LTD., Kunshan City (CN); LI YANG ELECTRIC MACHINERY (DONGGUAN) CO., LTD., Dong Guan City (CN)

(72) Inventor: Shang-Tsai WU, New Taipei City (TW)

(21) Appl. No.: 18/792,710

(22) Filed: Aug. 2, 2024

(51) Int. Cl. H01R 9/24

(52) U.S. Cl. CPC H01R 9/2416

(57) ABSTRACT

A horizontal feeding terminal block structure is disclosed. The terminal block structure (10) includes: an insulation seat (1) having a chamber (11), two fasten blocks (12) and two horizontal wire passing slots (14); and a connection terminal module (2) disposed in the chamber (11) and including a fixed terminal (21) and two pullable terminals (22), the fixed terminal (21) has a transversal sheet (211) and two longitudinal sheets (212), an axial direction of each of the horizontal wire passing slots (14) is parallelly arranged relative to the transversal sheet (211), the two pullable terminals (22) abut against the two fasten blocks (12) and has a pullable sheet (223) used to block between each of the horizontal wire passing slots (14) and the chamber (11) and a block sheet (222) disposed corresponding to each of the pullable sheets (223).

### BACKGROUND OF THE DISCLOSURE

### Technical Field

The present disclosure relates to a terminal block structure, especially to a horizontal feeding terminal block structure.

### Description of Related Art

A terminal block is commonly used as a connection unit and has been widely applied in an equipment compactly integrating the industrial communication devices having tremendous amount of data, thus the reliability of the power system is enhanced, the safety of the power industry is increased, and the level of the automated industry control field is higher.

A related-art terminal block structure includes a plastic frame and a connection terminal module disposed in the plastic frame. The connection terminal module includes an upper elastic sheet and a lower elastic sheet fastened at two sides of the plastic frame. One end of the upper elastic sheet has a free end abutting against the lower elastic sheet. When a conductive wire is inserted between the free end of the upper elastic sheet and the lower elastic sheet, the free end of the upper elastic sheet is elastically recovered towards the lower elastic sheet, thus the conductive wire is clamped between the free end of the upper elastic sheet and the lower elastic sheet, thus the conductive wire, the upper elastic sheet and the lower elastic sheet are electrically connected.

However, the related-art terminal block structure has a wire feeding port allowing a conductive wire to be inserted, an acute angle about 30 to 60 degrees is formed between an axial direction of the wire feeding port and a horizontal plane, in other words the wire feeding port is obliquely disposed relative to the horizontal plane. When the conductive wire is inserted in the terminal block structure, a portion of the conductive wire exposed outside the terminal block structure is required to be manually bent to make the conductive wire be in a horizontal status. Because most of the conductive wires has a great hardness and the diameter thereof is large, the manual bending operation is difficult and inconvenient.

Accordingly, the applicant of the present disclosure has devoted himself for improving the mentioned shortages.

### SUMMARY OF THE DISCLOSURE

The present disclosure is to provide a horizontal feeding terminal block structure, in which an axial direction of each horizontal wire passing slot is parallelly arranged relative to a transversal sheet, thus the terminal block structure has advantages of making an inserted wire material naturally be in a horizontal status and increasing the operation convenience.

Accordingly, the present disclosure provides a horizontal feeding terminal block structure, which includes: an insulation seat, having a chamber disposed at an inner side thereof, extended with two fasten blocks disposed in the chamber and two horizontal wire passing slots communicating with the chamber and disposed at an outer side thereof; and a connection terminal module, disposed in the chamber and including: a fixed terminal having a transversal sheet and two longitudinal sheets upwardly extended from two ends of the transversal sheet, wherein each of the fasten blocks and the transversal sheet are respectively disposed at a top side and a bottom side of each of the horizontal wire passing slots, an axial direction of each of the horizontal wire passing slots is parallelly arranged relative to the transversal sheet; and two pullable terminals, abutting against the two fasten blocks, wherein an outer end of each of the pullable terminals is extended with a pullable sheet disposed at an outer side of each of the longitudinal sheets and used to block between each of the horizontal wire passing slots and the chamber and an inner end of each of the pullable terminals is extended with a block sheet disposed corresponding to each of the pullable sheets.

Advantages provided by the present disclosure are as follows. The axial direction of each of the horizontal wire passing slots is parallelly arranged relative to the transversal sheet. When a wire material such as a conductive wire or a cable is inserted in the horizontal wire passing slot, a portion of the wire material such as the conductive wire or the cable exposed outside the terminal block structure is naturally be in a horizontal status, and a step of manually bending the wire material such as the conductive wire or the cable is saved. As such, the terminal block structure has advantages of making the inserted wire material naturally be in the horizontal status and increasing the operation convenience.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective exploded view showing the terminal block structure according to the present disclosure;

FIG. 2 is a perspective view showing the assembly of the terminal block structure according to the present disclosure;

FIG. 3 is a cross sectional view showing the terminal block structure according to the present disclosure;

FIG. 4 is a schematic view showing an operating status of the terminal block structure according to the present disclosure;

FIG. 5 is a schematic view showing another operating status of the terminal block structure according to the present disclosure;

FIG. 6 is a schematic view showing another operating status of the terminal block structure according to the present disclosure; and

FIG. 7 is a schematic view showing one another operating status of the terminal block structure according to the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

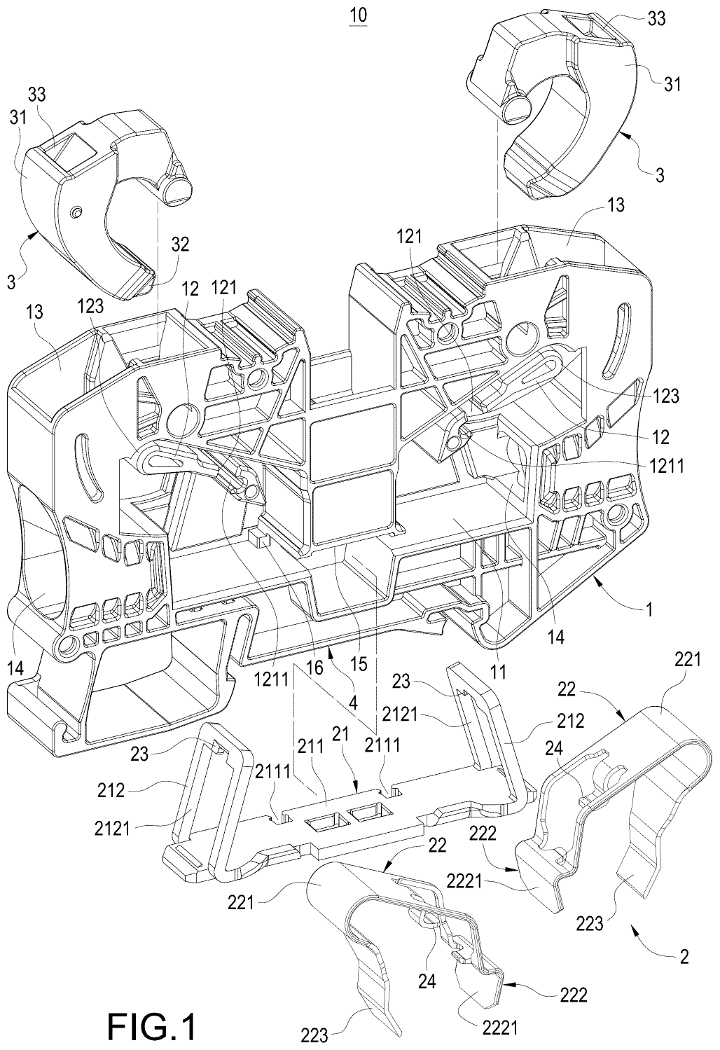

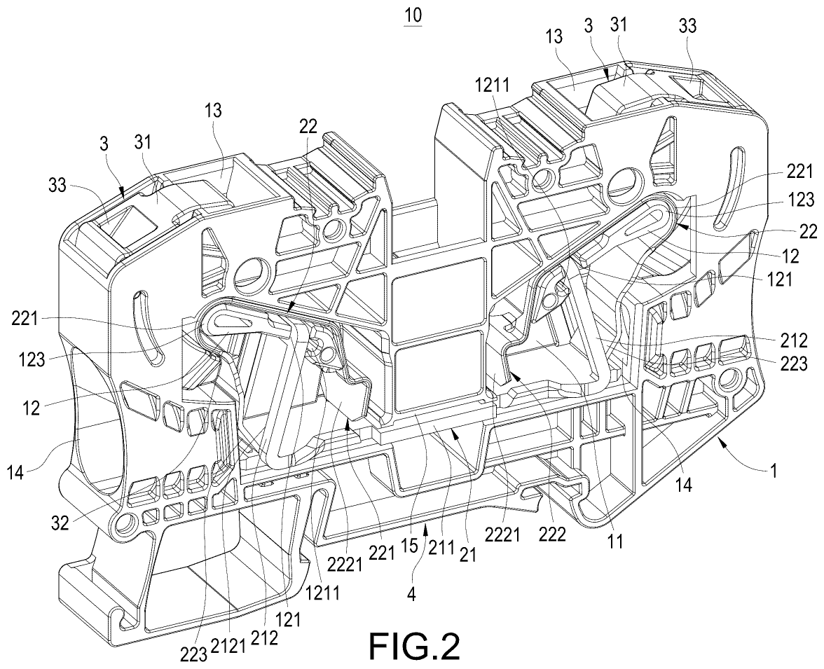

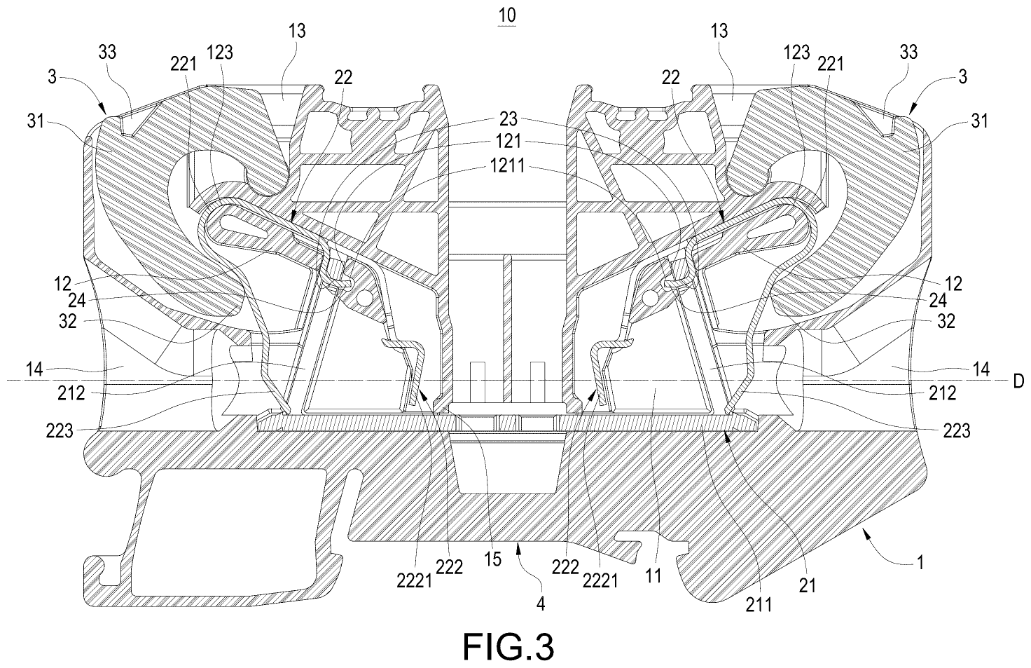

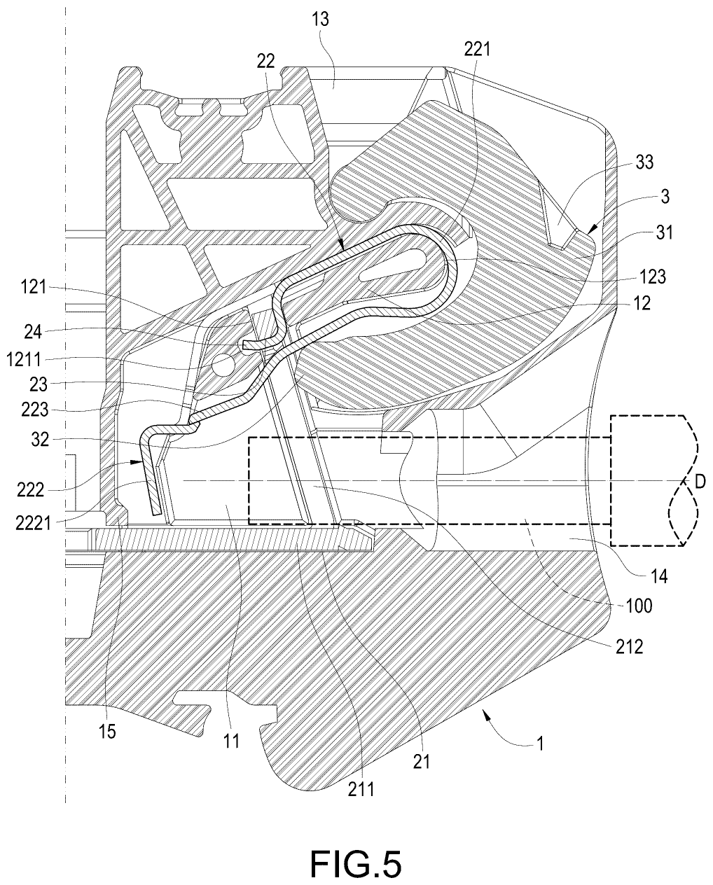

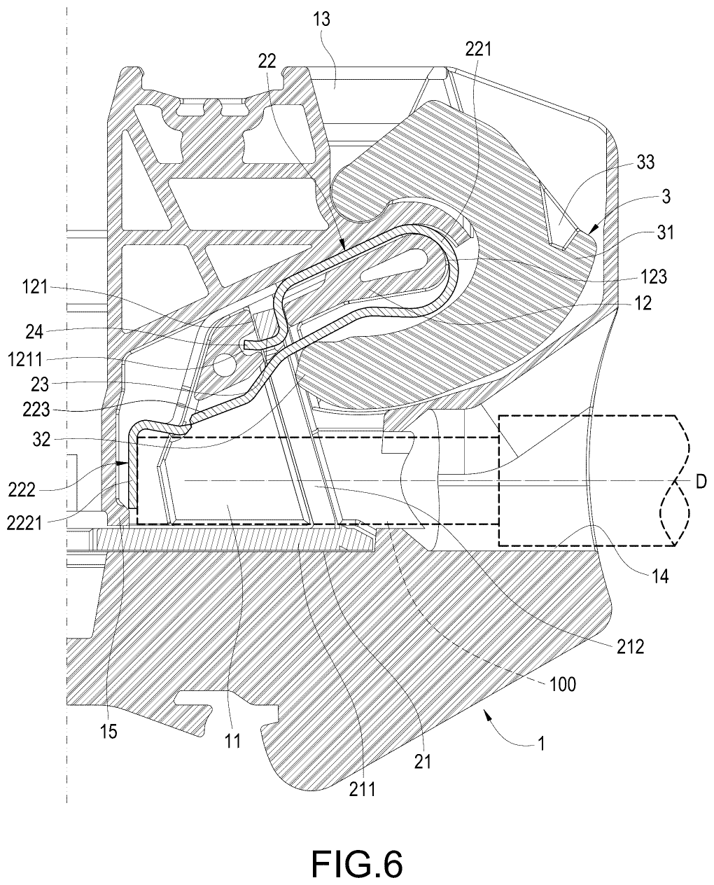

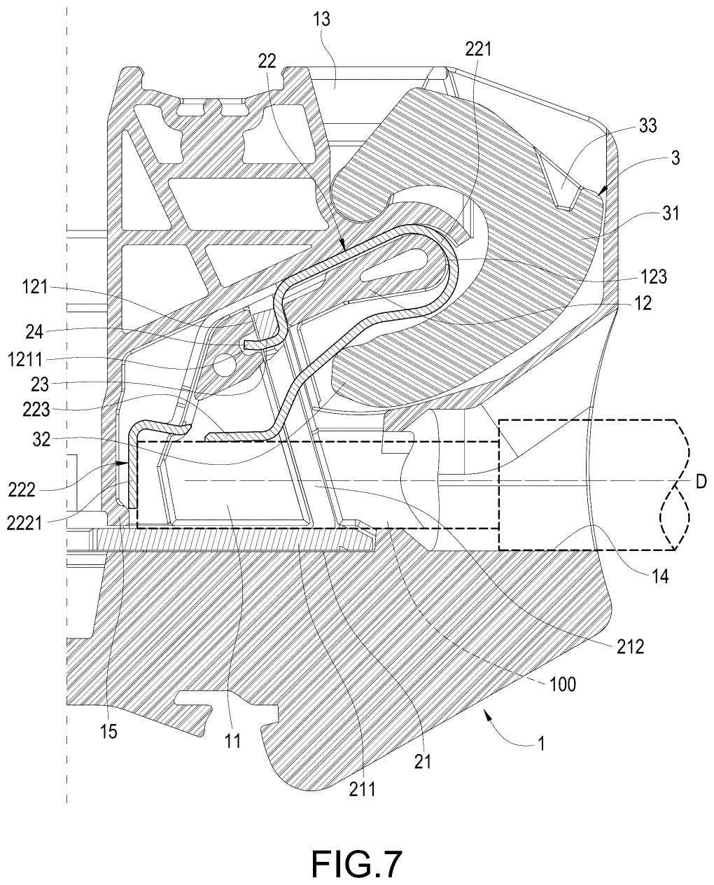

Please refer from FIG. 1 to FIG. 7, the present disclosure provides a horizontal feeding terminal block structure. The terminal block structure 10 mainly includes an insulation seat 1 and a connection terminal module 2.

As shown from FIG. 1 to FIG. 7, the insulation seat 1 is made of a plastic material. A chamber 11 is disposed at an inner side of the insulation seat 1. Two fasten blocks 12 are extended in the chamber 11. Two communication slots 13 and two horizontal wire passing slots 14 communicating with the chamber 11 are disposed at an outer side of the insulation seat 1. The two communication slots 13 are arranged at a top end of the chamber 11. A rail latching part 4 capable of latching with a rail (not shown in figures) is disposed at a bottom end of the insulation seat 1.

The two horizontal wire passing slots 14 are disposed at a left side and a right side of the insulation seat 1, thus the two horizontal wire passing slots 14 are arranged at a left side and a right side of the chamber 11. Axial directions D of the two horizontal wire passing slots 14 intersect on the same horizontal line. The two fasten blocks 12 are disposed at an upper segment of the chamber 11. The two horizontal wire passing slots 14 communicate with a lower segment of the chamber 11.

Details are provided as follows. Appearances of the two fasten blocks 12 are symmetrical in a left/right manner. A top surface of each of the fasten blocks 12 has a penetrated hole 121 and one end thereof has an arc-shaped end 123. An inner wall of each of the penetrated holes 121 is formed with a concave hole 1211. A bottom protruding column 15 and a plurality of protrusions 16 are extended at the inner side of the insulation seat 1 and arranged in the chamber 11.

Please refer from FIG. 1 to FIG. 7, the connection terminal module 2 is disposed in the chamber 11. The connection terminal module 2 includes a fixed terminal 21 and two pullable terminals 22. The fixed terminal 21 and the pullable terminals 22 are made of a conductive metal material. A thickness of the fixed terminal 21 is greater than a thickness of each of the pullable terminals 22.

Details are provided as follows. The fixed terminal 21 has a transversal sheet 211 disposed corresponding to a bottom edge of each of the horizontal wire passing slots 14 and two longitudinal sheets 212 upwardly extended from two ends of the transversal sheet 211. Each of the fasten blocks 12 and the transversal sheet 211 are respectively disposed at a top side and a bottom side of each of the horizontal wire passing slots 14. The axial direction of each of the horizontal wire passing slots 14 is parallel to the transversal sheet 211.

A middle segment of the transversal sheet 211 is blocked by the bottom protruding column 15. The transversal sheet 211 has a plurality of notches 2111. Each of the protrusions 16 is latched in each of the notches 2111, thus the transversal sheet 211 is stably positioned in the chamber 11. Each of the longitudinal sheets 212 passes each of the penetrated holes 121, thus the two longitudinal sheets 212 are inserted in the two fasten blocks 12.

Each of the pullable terminals 22 has a U-shaped bending sheet 221. A central portion of each of the U-shaped bending sheet 221 abuts against each of the arc-shaped ends 123, thus the two pullable terminals 22 stably abut against the two fasten blocks 12. An outer end of each of the pullable terminals 22 is extended with a pullable sheet 223 disposed at an outer side of each of the longitudinal sheets 212 and used to block between each of the horizontal wire passing slots 14 and the chamber 11. An inner end of each of the pullable terminals 22 is extended with a block sheet 222 disposed corresponding to each of the pullable sheets 223. Each of the block sheets 222 and each of the pullable sheets 223 are extended form two ends of each of the U-shaped bending sheets 221.

Each of the longitudinal sheets 212 has a latching groove 23. An inner side of each of the U-shaped bending sheets 221 is extended with a latching tenon 24. Each of the latching tenons 24 is latched in each of the latching grooves 23. A distal end of each of the latching tenons 24 penetrates each of the penetrated holes 121 and is latched in each of the concave holes 1211.

Each of the longitudinal sheets 212 is formed with a hollow port 2121 disposed corresponding to each of the horizontal wire passing slots 14. Each of the pullable sheets 223 penetrate each of the hollow ports 2121. Each of the latching grooves 23 is concavely arranged at an inner circumference of each of the hollow ports 2121. A distal end of each of the block sheets 222 is bent to form a reverse L-shaped block part 2221. Each of the reverse L-shaped parts 2221 is used to block a distal end of a wire material 100 such as a conductive wire or a cable.

The transversal sheet 211 and each of the longitudinal sheets 212, which are extended to be formed as one piece, are formed in a U-shape. Each of the pullable terminals 22 are formed in a reverse V-shape. As such, a butterfly-shaped frame is formed by the fixed terminal 21 and the two pullable terminals 22 mutually abutting against each other.

Please refer from FIG. 1 to FIG. 7, the terminal block structure 10 of the present disclosure further includes two inwardly pushing handles 3. Each of the inwardly pushing handles 3 is disposed in each of the communication slots 13. One end of each of the inwardly pushing handles 3 is pivotally connected to the insulation seat 1 and another end thereof abuts against each of the pullable sheets 223.

Details are provided as follows. Each of the inwardly pushing handles 3 is a U-shaped handle 31. One end of each of the U-shaped handles 31 is pivotally connected to the insulation seat 1 and disposed at a top end of each of the U-shaped bending sheets 221, another end of each of the U-shaped handles 31 has a moveable end 32 abutting against each of the pullable sheets 223 and a middle portion of each of the U-shaped handles 31 has a pushing/pressing concave port 33 exposed at each of the communication slots 13. By inserting a flat object (not shown in figures) such as a screwdriver in the pushing/pressing concave port 33, the U-shaped handle 31 is driven to rotate, thus the moveable end 32 inwardly pushes the pullable sheet 223 to move towards the horizontal wire passing slot 14.

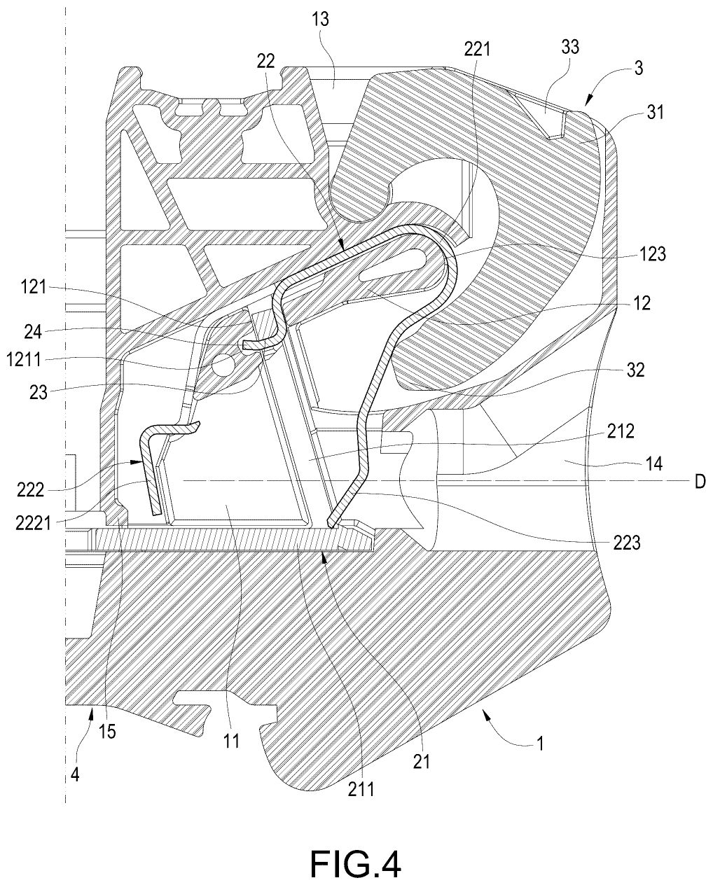

Please refer from FIG. 4 to FIG. 7, which disclose operating status of the terminal block structures 10 of the present disclosure. A flat object such as a screwdriver is inserted in the pushing/pressing concave port 33, the inwardly pushing handle 3 is driven to rotate, thus the moveable end 32 is driven to inwardly push the pullable sheet 223 towards the horizontal wire passing slot 14, and then the wire material 100 such as the conductive wire or the cable is inserted in the horizontal wire passing slot 14 till being blocked by the block sheet 222, at this moment the inwardly pushing handle 3 is released, the pullable sheets 223 is recovered towards a position which blocks between each of the horizontal wire passing slots 14 and the chamber 11, lastly the wire material 100 such as the conductive wire or the cable is clamped between the transversal sheet 211 and the pullable sheet 223, in other words the wire material 100 such as the conductive wire or the cable is clamped between the fixed terminal 21 and the pullable terminals 22. As such, a wire connecting operation of the terminal block structure 10 is finished.

According to the present disclosure, the bottom end of the insulation seat 1 is latched on the rail via the rail latching part 4, thus the transversal sheet 211 is arranged with a manner of being parallel to a horizonal plane, and the axial direction D of each of the horizontal wire passing slots 14 is parallelly arranged relative to the transversal sheet 211, thus the axial direction D of each of the horizontal wire passing slots 14 is parallel to the horizontal plane. When the wire material 100 such as the conductive wire or the cable is inserted in the horizontal wire passing slot 14, a portion of the wire material 100 such as the conductive wire or the cable exposed outside the terminal block structure 10 is naturally in a horizontal status, and a step of manually bending the wire material 100 such as the conductive wire or the cable is saved. As such, the terminal block structure 10 has advantages of making the inserted wire material 100 naturally be in the horizontal status and increasing the operation convenience.

The related-art wire feeding port is obliquely disposed relative to the horizontal plane, the axial direction D of the horizontal wire passing slot 14 of the present disclosure is parallelly arranged relative to the horizontal plane, and the inwardly pushing handle 3 is configured to be a rotary type and located above the pullable terminal 22 and close to the pullable sheet 223, thus a smaller pushing force is required to make the inwardly pushing handle 3 smoothly push the pullable sheet 223, thus the terminal block structure 10 further has an advantage of requiring a smaller inserting force.

While this disclosure has been described by means of specific embodiments, numerous modifications and variations could be made thereto by those skilled in the art without departing from the scope and spirit of this disclosure set forth in the claims.

What is claimed is:

1. A terminal block structure, comprising:
an insulation seat (1), comprising a chamber (11) defined at an inner side thereof, two fasten blocks (12) disposed in the chamber (11), and two horizontal wire passing slots (14) communicating with the chamber (11) and defined at an outer side thereof; and
a connection terminal module (2), disposed in the chamber (11) and comprising:
a fixed terminal (21), comprising a transversal sheet (211) and two longitudinal sheets (212) upwardly extended from two ends of the transversal sheet (211), wherein each of the fasten blocks (12) and the transversal sheet (211) are respectively disposed at a top side and a bottom side of each of the horizontal wire passing slots (14), and an axial direction of each of the horizontal wire passing slots (14) is parallelly arranged relative to the transversal sheet (211); and
two pullable terminals (22), abutting against the two fasten blocks (12), wherein an outer end of each of the pullable terminals (22) is extended with a pullable sheet (223) disposed at an outer side of each of the longitudinal sheets (212) and blocking between each of the horizontal wire passing slots (14) and the chamber (11), and an inner end of each of the pullable terminals (22) is extended with a block sheet (222) disposed corresponding to each of the pullable sheets (223).

2. The terminal block structure according to claim 1, wherein the two horizontal wire passing slots (14) are disposed at a left side and a right side of the insulation seat (1), and the axial directions of the two horizontal wire passing slots (14) intersect on a same horizontal line.

3. The terminal block structure according to claim 1, wherein the two fasten blocks (12) are disposed at an upper segment of the chamber (11), the two horizontal wire passing slots (14) communicate with a lower segment of the chamber (11), and the transversal sheet (211) is disposed corresponding to a bottom edge of each of the horizontal wire passing slots (14).

4. The terminal block structure according to claim 1, wherein each of the fasten blocks (12) comprises a penetrated hole (121) defined on a top surface thereof and an arc-shaped end (123) disposed on one end thereof, each of the longitudinal sheets (212) penetrates each of the penetrated holes (121), each of the pullable terminals (22) comprises a U-shaped bending sheet (221), a central portion of each of the U-shaped bending sheets (221) abuts against each of the arc-shaped ends (123), and each of the block sheets (222) and each of the pullable sheets (223) are extended form two ends of each of the U-shaped bending sheets (221).

5. The terminal block structure according to claim 4, wherein each of the longitudinal sheets (212) comprises a latching groove (23), each of the U-shaped bending sheets (221) comprises a latching tenon (24) disposed on an inner side thereof, and each of the latching tenons (24) is latched in each of the latching grooves (23).

6. The terminal block structure according to claim 5, wherein each of the penetrated holes (121) comprises a concave hole (1211) defined on an inner wall thereof, and a distal end of each of the latching tenons (24) penetrates each of the penetrated holes (121) and is latched in each of the concave holes (1211).

7. The terminal block structure according to claim 5, wherein each of the longitudinal sheets (212) comprises a hollow port (2121) defined corresponding to each of the horizontal wire passing slots (14), each of the pullable sheets (223) penetrates each of the hollow ports (2121), each of the latching grooves (23) is concavely arranged at an inner circumference of each of the hollow ports (2121), and a distal end of each of the block sheets (222) is bent to be a reverse L-shaped block part (2221).

8. The terminal block structure according to claim 4, further comprising two inwardly pushing handles (3), the insulation seat (1) further comprising two communication slots (13) defined on the outer side thereof and communicating with the chamber (11), each of the inwardly pushing handle (3) is disposed in each of the communication slots (13), and one end of each of the inwardly pushing handles (3) is pivotally connected to the insulation seat (1) and another end of each of the inwardly pushing handles (3) abuts against each of the pullable sheets (223).

9. The terminal block structure according to claim 8, wherein each of the inwardly pushing handles (3) is a U-shaped handle (31), one end of each of the U-shaped handles (31) is pivotally connected to the insulation seat (1) and disposed at a top end of each of the U-shaped bending sheets (221), and each of the U-shaped handles (31) comprises a moveable end (32) abutting against each of the pullable sheets (223) disposed on another end thereof and a pushing/pressing concave port (33) exposed from each of the communication slots (13) defined on a middle portion thereof.

10. The terminal block structure according to claim 1, wherein the insulation seat (1) further comprises a bottom protruding column (15) and a plurality of protrusions (16) disposed in the chamber (11), a middle segment of the transversal sheet (211) is blocked by the bottom protruding column (15), and the transversal sheet (211) comprises a plurality of notches (2111), and each of the protrusions (16) is latched in each of the notches (2111).
